(19) United States
(12) Patent Application Publication
(10) Pub. No.: US 2019/0064525 A1
(43) Pub. Date: Feb. 28, 2019

(54) DEVICE FOR IMPROVING SAFETY DURING AERONAUTICAL MANEUVERS

(71) Applicant: FREEFALL DATA SYSTEMS LLC, LOMPOC, CA (US)

(72) Inventor: Casey Patrick Mongoven, Lompoc, CA (US)

(21) Appl. No.: 16/113,742

(22) Filed: Aug. 27, 2018

Related U.S. Application Data
(63) Continuation-in-part of application No. 15/918,698, filed on Mar. 12, 2018.
(60) Provisional application No. 62/551,112, filed on Aug. 28, 2017.

(51) Int. Cl. G02B 27/01; G01C 5/06

(52) U.S. Cl. CPC G02B 27/0172; A63G 2031/005; G01C 5/06

(57) ABSTRACT

An altitude display device is provided for use when skydiving. The altitude display device may include an altimeter operative to determine an altitude of the altimeter and to generate an altitude signal representative of the determined altitude. The altitude display device may additionally include a visual display in operative communication with the altimeter to receive the altitude signal, with the visual display emitting a visual display signal at a rate that is imperceptible to a human user, and having a color representative of the altitude signal. The visual display signal may be variable in color within a prescribed color range associated with a prescribed altitude range, such that a change in altitude within the prescribed altitude range, as determined by the altimeter, correlates to a change in color of the visual display signal emitted by the visual display within the prescribed color range.

### CROSS-REFERENCE TO RELATED APPLICATIONS

This application is a continuation-in-part of U.S. application Ser. No. 15/918,698, filed Mar. 12, 2018, which claims the benefit of U.S. Provisional Application No. 62/551,112, filed Aug. 28, 2017, the contents of each of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a visual display device for use while performing aeronautical maneuvers.

### 2. Description of the Related Art

An inherent issue commonly associated with skydiving is knowing when to deploy the parachute, as well as guidance toward a desired landing zone. Accordingly, there is a need in the art for an improved device and method that addresses this issue.

### BRIEF SUMMARY

Various aspects of the present disclosure relate to an altitude display device for use in skydiving. The altitude display device may emit light at a color associated with a particular altitude. As a skydiver descends during a skydive, the color emitted by the altitude display device may change by sequencing through the colors of the rainbow, which may visually represent a change in altitude between an exit altitude from an aircraft and a parachute deployment altitude. The light may be emitted at a refresh rate that may be imperceptible to the human eye, such that the light may appear to continuously blend from one color to the next.

According to one embodiment, there may be provided an altitude display device for use when skydiving. The altitude display device may include an altimeter operative to determine an altitude of the altimeter and to generate an altitude signal representative of the determined altitude. The altitude display device may additionally include a visual display in operative communication with the altimeter to receive the altitude signal, with the visual display emitting a visual display signal at a refresh rate that is imperceptible to a human user and having a color representative of the altitude signal. The visual display signal may be variable in color within a prescribed color range associated with a prescribed altitude range, such that a change of altitude within the prescribed altitude range, as determined by the altimeter, correlates to a change of color of the visual display signal emitted by the visual display within the prescribed color range.

The altitude display device may include a shaft connected to the visual display and connectable to a helmet wearable by a user. The shaft may be flexible. The visual display may be positioned adjacent an end of the shaft.

The visual display may include at least one light emitting diode capable of emitting a range of colors. The visual display may emit the visual display signal at a refresh rate greater than 30 Hz.

The altitude display device may further include a microcontroller in operative communication with the altimeter and the visual display. The microcontroller may receive the altitude signal from the altimeter and may generate command signals for visual display based on the received altitude signal. The altitude display device may include a wireless circuit in communication with the microcontroller to facilitate wireless communication with a remote electronic device. The microcontroller may be operative to define at least one end of the prescribed altitude range based on a change in altitude as determined by the altimeter.

The prescribed altitude range may be associated with a lower boundary altitude. The visual display signal may be emitted at a first frequency when the determined altitude is above the lower boundary altitude. The visual display signal may be emitted at a second frequency lower than the first frequency when the determined altitude is below the lower boundary altitude.

The visual display may be operable in a first mode to generate the visual display signal having a color representative of the altitude signal, and in a second mode to generate the visual display signal having a color representative of a vertical descent speed.

According to another embodiment, there may be provided a method of displaying altitude information to a user. The method may include determining an altitude using an altimeter, and generating an altitude signal by the altimeter, with the altitude signal being representative of the determined altitude. The method may further include emitting a visual display signal by a visual display at a refresh rate imperceptible to a human user, with the visual display signal having a color representative of the altitude signal. The method may additionally comprise varying the color of the visual display signal within a prescribed color range associated with a prescribed altitude range, such that a change of altitude within the prescribed altitude range, as determined by the altimeter, correlates to a change of color of the visual display signal emitted by the visual display within the prescribed color range.

The method may include generating the visual display signal adjacent an end of a shaft connected to a helmet wearable by the user. The method may comprise generating the visual display signal by a light emitting diode capable of emitting a range of colors. The method may include emitting the visual display the visual display signal at a refresh rate greater than 30 Hz.

The method may additionally comprise the steps of receiving the altitude signal from the altimeter at a microcontroller, and generating, by the microcontroller, command signals for the visual display based on the received altitude signal.

The method may include the step of defining, by a microcontroller, at least one end of the prescribed altitude range based on a change in altitude as determined by the altimeter.

The prescribed altitude range may be associated with a lower boundary altitude, and the method may additionally include emitting the visual display signal by the visual display at a first frequency when the determined altitude is above the lower boundary altitude, and emitting the visual display signal by the visual display at a second frequency lower than the first frequency when the determined altitude is below the lower boundary altitude.

According to another embodiment, there may be provided an altitude display device for use when skydiving. The altitude display device may include an altimeter operative to determine an altitude of the altimeter and to generate an altitude signal representative of the determined altitude. A visual display may be in operative communication with the altimeter to receive the altitude signal. The visual display may emit a visual display signal at a refresh rate that is imperceptible to a human user and that transitions within a first color range when the altitude signal is representative of a first altitude range, and a second color range when the altitude signal is representative of a second altitude range.

The altitude display device may include a microcontroller in communication with the altimeter and the visual display. The microcontroller may generate command signals for the visual display. The microcontroller may be capable of receiving user input to define the first color range, the first altitude range, the second color range, and the second altitude range.

There may also be provided an eyewear device for use when skydiving. The eyewear device may include a lens positionable over a user's eyes, with the lens defining a viewing axis passing through the lens and dividing the lens into a pair of lateral regions. The eyewear device may also include a compass to detect a directional heading of the viewing axis of the lens and generate a first signal representative of the detected directional heading. A controller may be in communication with the compass to receive the first signal from the compass, and generate a light command signal based on a comparison of the detected directional heading with a preset directional heading range. A pair of lights may be in operative communication with the controller and located in respective ones of the pair of lateral regions of the lens. The pair of lights may be capable of operating based on the light command signal to emit a visual alert to convey directional guidance to the user.

The light command signal may include instructions for operating the pair of lights in a first mode when the detected directional heading falls within the preset directional heading range and a second mode when detected directional heading falls outside of preset directional heading range. In the first mode, the pair of lights may emit a common color of light, and in the second mode, the pair of lights may emit different colors of light. In the first mode, the pair of lights may emit light at a common refresh rate, and in the second mode, the pair of lights may emit light at a different refresh rate.

The pair of lights may emit the visual alert at a refresh rate that is imperceptible to a human user. The pair of lights may emit the visual alert at a refresh rate that is greater than 30 Hz.

The eyewear device may include an altimeter in communication with the controller and operative to determine an altitude of the altimeter. The pair of lights may be in operative communication with the altimeter to emit the visual alert having a color representative of the determined altitude.

The eyewear device may include a speaker coupled to the lens. The speaker may be capable of emitting an audible signal to the user. The controller may generates an audible command signal based on a comparison of the detected directional heading with a preset directional heading range. The speaker may be in communication with the controller to receive the audible command signal therefrom and generate the audible signal based on the audible command signal. The eyewear device may include a microphone to detect a magnitude of ambient noise and generate an ambient noise signal. The controller may be in communication with the microphone and may generate the audible command signal based on the detected magnitude of ambient noise.

There may also be provided a wearable device for providing directional guidance to a skydiver. The device may include a frame wearable by the skydiver and defining a frame axis and a pair of lateral regions. The device may also include a compass to detect a directional heading of the frame axis and generate a first signal representative of the detected directional heading. A controller may be in communication with the compass to receive the first signal from the compass, and may generate a light command signal based on a comparison of the detected directional heading with a preset directional heading range. A pair of lights may be in operative communication with the controller and may be located in respective ones of the pair of lateral regions of the lens. The pair of lights may be capable of operating based on the light command signal to emit a visual alert to convey directional guidance to the user.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a skydiving helmet worn by a user, the skydiving helmet being fitted with an altitude display device according to an embodiment of the present disclosure;

FIG. 2 is an upper perspective view of the altitude display device;

FIG. 3 is a schematic diagram of the electrical components in one embodiment of the altitude display device;

FIG. 4 is a plan view of a handheld electronic device in wireless communication with a control unit of the altitude display device

FIG. 5 is a first side perspective view of an eyewear device for conveying position information to a skydiver;

FIG. 6 is a second side perspective view of the eyewear device of FIG. 5;

FIG. 7 is a front view of the eyewear device of FIG. 5;

FIG. 8 is a rear view of a lens assembly including a lens and a frame, the lens assembly being included in the eyewear device of FIG. 5;

FIG. 9 is rear view of the lens;

FIG. 10 is a front view of the lens;

FIG. 11 is a schematic diagram of the electrical components in one embodiment of a system including the eyewear device shown in FIG. 5;

FIG. 12 is a schematic diagram comparing a viewing axis heading with a desired heading;

FIG. 13 is a perspective view of a battery assembly which is included in the eyewear device of FIG. 5;

FIG. 14 is a perspective view of a control unit which is included in the eyewear device of FIG. 5;

FIG. 15 is an upper perspective view of an elastic band useable with the lens assembly;

FIG. 16 is a screenshot of an application (i.e., “app”) running on a smartphone depicting various operational modes;

FIG. 17 is a screenshot of the app running on the smartphone for setting visual alert characteristics on the eyewear device for skydiving;

FIG. 18 is a screenshot of the app running on the smartphone for setting audible alert characteristics on the eyewear device for skydiving;

FIG. 19 is a screenshot of the app running on the smartphone for various operational options for operating the eyewear in a BASE jumping mode;

FIG. 20 is a screenshot of the app running on the smartphone for various operational options for operating the eyewear in a paragliding/hang gliding mode; and

FIG. 21 is a screenshot of the app running on the smartphone for setting and calibrating an external master device connected to an angle of attack (AoA) indicator.

Common reference numerals are used throughout the drawings and the detailed description to indicate the same elements.

### DETAILED DESCRIPTION

Referring now to the drawings wherein the showings are for purposes of illustrating a preferred embodiment of the present disclosure, and are not for purposes of limiting the same, there is depicted an altitude display device for use when skydiving. The altitude display device may include a light emitting diode (LED) that emits light having a color correlated to a particular altitude. Accordingly, while the user is skydiving and experiencing a continuous change in altitude, the color of the LED may continuously sequence through the colors of the rainbow. The change in color of the LED may appear to be continuous or uninterrupted to the skydiver by blending the color at a refresh rate that is imperceptible to the skydiver, e.g., greater than the average eye can detect, such as greater than 30-60 Hz.

The user may assign one particular color with an exit altitude from an aircraft, and another color with a parachute deployment altitude, and as such, the color emitted by the LED during descent may sequence through the colors of the rainbow from the exit altitude color to the parachute deployment color. The colors of the rainbow are well-known to almost everyone, and therefore, a skydiver may be able to track the change of color from the exit altitude color to the parachute deployment color. For instance, if the exit altitude color is blue and the parachute deployment color is red, a skydiver may anticipate that during descent, the LED will transition from blue to green, to yellow, to orange, and finally to red. Therefore, if after exiting the aircraft, the skydiver looks at the LED and sees that it is green, the skydiver will know he is closer to the exit altitude than the parachute deployment altitude, and that the time for initiating the parachute deployment process is not yet approaching. If the skydiver looks at the LED and sees that it is yellow, the skydiver may know that he is approximately halfway between the exit altitude and the parachute deployment altitude. If the skydiver looks at the LED and sees that the color is orange, the skydiver may know that the parachute deployment altitude is quickly approaching, and therefore, greater attention may be devoted toward ensuring the skydiver is ready for deployment. Finally, when the skydiver sees the LED transition to red, the skydiver will know that it is time to deploy the parachute. Accordingly, the color emitted by the LED may not only be useful for estimating the current altitude of the skydiver, but because of the familiarity with the sequence of colors, the color emitted by the LED may allow the skydiver to anticipate how much altitude and time is left before parachute deployment. Being able to anticipate the amount of altitude and time left in the jump may be very useful, as there is usually a brief window of approximately four seconds within which the skydiver needs to deploy the parachute. Anticipating the parachute deployment altitude helps to ensure the skydiver is ready for deployment. If the user was merely alerted to the parachute deployment altitude at the beginning of the brief four second window, the skydiver may not be able to execute all of the steps that may be required for parachute deployment within the brief window. For instance, if the skydiver blinks at the beginning of the four second window, the skydiver may miss the beginning of that window, and only be left with a smaller amount of time. As such, the continuous signal emitted by the LED and the familiarity of the color sequencing of the altitude display device may provide an easy to decipher, yet critically valuable, visual signal to the skydiver to enhance the performance and safety of the skydive.

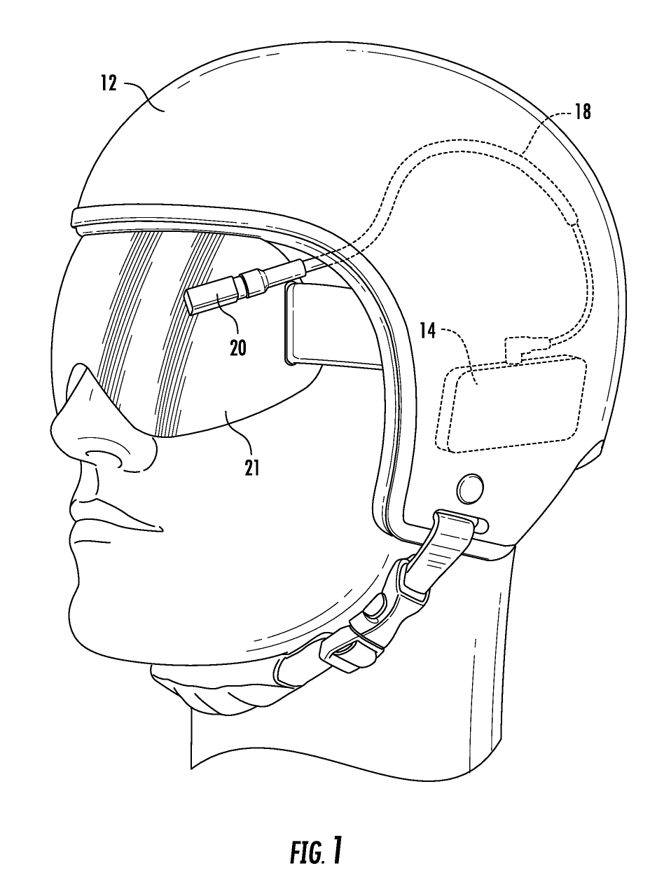

Referring now specifically to FIG. 1, one embodiment of an altitude display device 10 is shown in use with a skydiving helmet 12 worn by a user. The altitude display device 10 generally includes a control unit 14, and a display unit 16 connectable to the control unit 14. The control unit 14 may include a housing 15 for several electronic components which implement various functionalities of the altitude display device 10, as described in more detail herein. The display unit 16 may include a flexible shaft 18 and a visual display 20 connected to a distal end of the flexible shaft 18 for providing a visual display signal to the user. The flexible shaft 18 is sized so as to extend outside of the helmet 12 to allow a user to position the visual display 20 in a location which may reside within a field of view of the user during use, with the visual display 20 remaining substantially stationary in the field of view during the skydive. The user may wear goggles 21 or other eyewear, and the visual display 20 may be positioned so as not to interfere with the fit and use of the goggles 21.

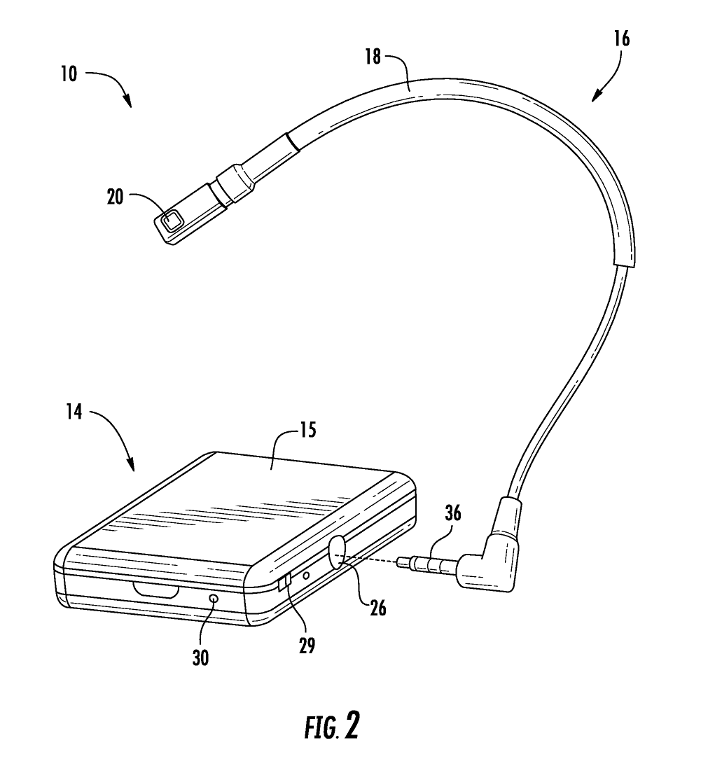

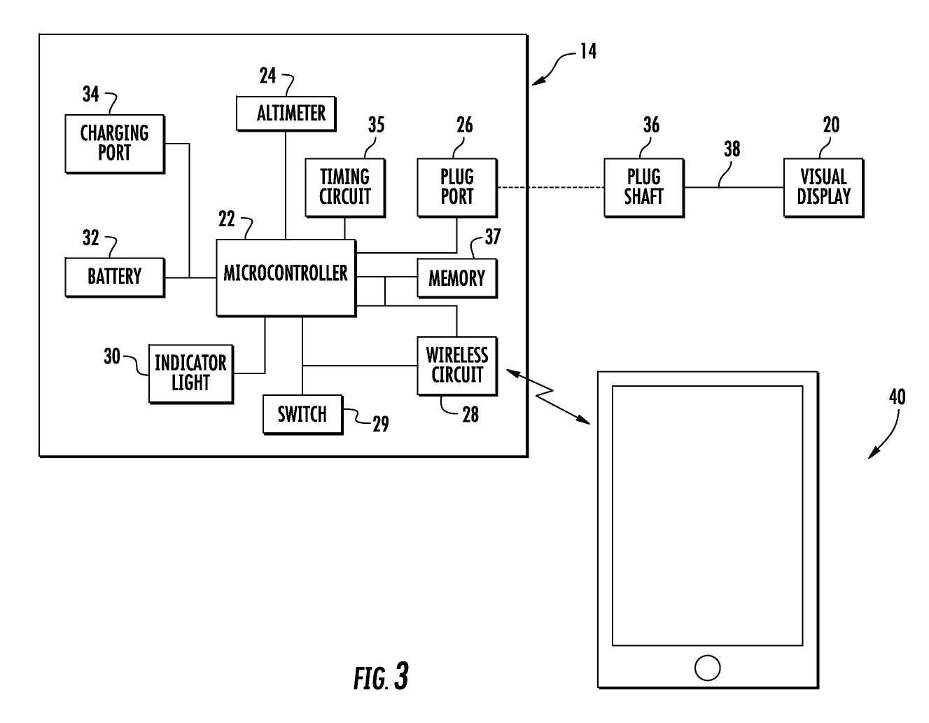

FIG. 2 shows the altitude display device 10 by itself, i.e., removed from the helmet 12, while FIG. 3 is a schematic diagram of the electrical components of one embodiment of the altitude display device 10. In FIG. 2, the display unit 16 is shown as being detached from the control unit 14. The electrical components of the control unit 14 may include a microcontroller 22, an altimeter 24, a plug port 26, a wireless circuit 28, an indicator light 30, a battery 32, a charging port 34, a timing circuit 35, and memory 37. The electrical components of the display unit 16 include a plug shaft 36 and the visual display 20. The functionality of the electrical components will be described in more detail below.

The altimeter 24 determines an altitude of the control unit 14, and thus, when the control unit 14 is worn by the user, the altimeter 24 determines the altitude of the user. The altitude may be determined by the altimeter 24 based on a measurement of atmospheric pressure, i.e., a barometric altimeter, wherein the greater the altitude, the lower the pressure, and vice versa. One example of a barometric altimeter is a BMP280 sold by Robert Bosch GmbH. The altimeter 24 may employ another technique currently known, such as the Global Positioning System (GPS), or later developed, for determining altitude without departing from the spirit and scope of the present disclosure.

The altimeter 24 may generate an electrical signal, e.g., an altitude signal, which is representative of the determined altitude. Since the altimeter 24 may continuously determine the altitude during all phases of a skydive, i.e., ascent, freefall, and canopy flight, the altitude signal may be continuously generated from the beginning of ascent to the end of canopy flight when the skydiver lands, so as to reflect the continuous change in altitude. In one embodiment, the continuous generation of the altitude signal may be associated with a sampling rate of 12.5 Hz, although in some instances, the sampling rate is greater than 12.5 Hz, such as 30-60 Hz, or perhaps, even greater than 60 Hz. It is also contemplated that the sampling rate of the altimeter 24 may be synchronized with the refresh rate of the visual display 20.

The altimeter 24 may be in electrical communication with the microcontroller 22. One example of a microcontroller 22 is an ATmega32u4 by Atmel Corporation. The microcontroller 22 may be configured to receive the altitude signal from the altimeter 24 and generate a command signal for the visual display 20 based on the received altitude signal. In this respect, the microcontroller 22 may be programmed to correlate the altitude associated with the received altitude signal with a specific color or hue that is to be generated by the visual display 20. Accordingly, the command signal generated by the microcontroller 22 includes instructions for the visual display 20 to be illuminated at the color frequency associated with the determined altitude.

The visual display 20 is operative to emit the visual display signal in response to receipt of the command signal from the microcontroller 22. Depending on the operational mode of the altitude display device 10, the visual display signal may be emitted at any time during the duration of any phase of the skydive, including ascent, freefall and canopy flight. The visual display 20 may include one or more light emitting diode(s), or other light emitting devices known in the art capable of emitting a range of colors. For instance, the visual display 20 may include an RGB LED mounted on a circuit board located at the end of the flexible shaft 18. The visual display 20 is preferably of a size and shape that is discernable to the user, without blocking a significant portion of the user's field of view. Furthermore, the shape of the visual display 20 may be quadrangular, circular, triangular, or any other shape known in the art.

The visual display 20 may receive the command signal from the control unit 14 via an electrical pathway that extends between the microcontroller 22 and the visual display 20. In particular, the microcontroller 22 may be in electrical communication with the plug port 26, which may be externally accessible on the housing 15 of the control unit 14. The plug port 26 may be sized to receive the plug shaft 36, which when inserted into the plug port 26 may be in electrical communication with the plug port 26 through direct contact therewith. The plug shaft 36 is in electrical communication with the visual display 20 through wires 38 extending through the flexible shaft 18.

The battery 32 may provide power to the various components of the control unit 14. The battery 32 may be rechargeable by connecting the charging port 34 to an external power source. The charging port 34 may include a micro-USB port, a USB port, or other ports known in the art. When the charging port 34 is connected to an external power supply, and the battery 32 is being recharged, the indicator light 30 may be illuminated. The indicator light 30 may be configured to illuminate one color (e.g., red) when the battery 32 is charging, and another color (e.g., green) when the battery 32 is fully charged.

The control unit 14 may be programmable to implement various functionalities, as will be described in more detail below. According to one embodiment, programming of the control unit 14 may be achieved through a wireless circuit 28, capable of wireless communication with a remote electronic device 40, such as a smartphone, tablet computer, laptop computer, desktop computer, or other electronic device. The wireless circuit 28 may be actuated via a switch 29 on the control unit 14. One example of a wireless circuit 28 that may be included in the control unit 14 is a Bluetooth® wireless technology module, model number MDBT40-256RV3 sold by Raytac Corporation. In addition to Bluetooth® communication protocol, the wireless circuit 28 may communicate wirelessly in other communication protocols, including but not limited to, Zigbee, RFID, WiFi, etc. Although the exemplary embodiment includes a wireless circuit 28, it is contemplated that in other embodiments, programming of the control unit 14 may be achieved through wired communication between the control unit 14 and a remote electronic device 40. As such, the control unit 14 may include a programming port which may be connected to the remote electronic device, either directly, or through an intervening cable. As another alternative, the control unit 14 may include a user interface with a touch screen, buttons, or the like, which allows a user to program the control unit 14.

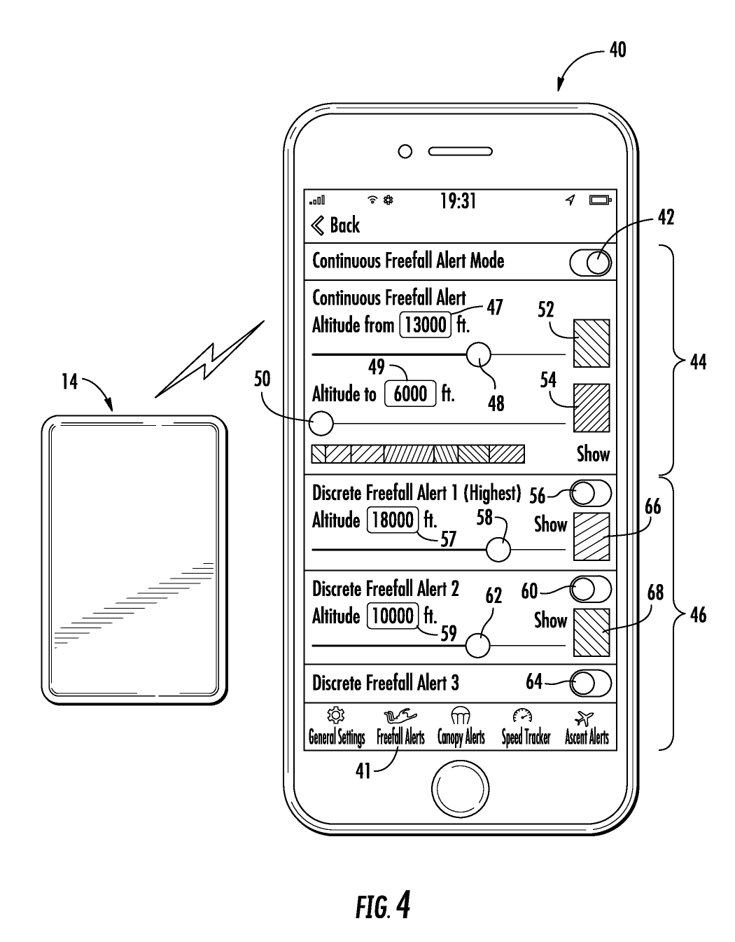

Referring now specifically to FIG. 4, it is contemplated that when a remote electronic device 40 is used to program the control unit 14, an application (“app.”) may run on the remote electronic device 40 to facilitate user input. FIG. 4 depicts a smartphone 40 displaying running an app, which allows the smartphone 40 to be used for programming the control unit 14. A programming menu is displayed on the touchscreen of the smartphone 40, with the programming menu providing several different operational modes for purposes of programming.

A first mode is associated with the FREEFALL ALERT button 41, which is related to the screenshot depicted on the smartphone 40 in FIG. 4. When the FREEFALL ALERT button 41 is pressed, a user can select CONTINUOUS FREEFALL ALERT MODE, or alternatively, a series of DISCRETE FREEFALL ALERTS. The CONTINUOUS FREEFALL ALERT MODE provides a visual alert between two altitudes, namely, an upper altitude and a lower altitude. The DISCRETE FREEFALL ALERTS are capable of providing visual alerts within a number of different altitude ranges.

The CONTINUOUS FREEFALL ALERT MODE may be used to vary the color emitted by the visual display 20 as the altitude varies between an upper altitude and a lower altitude. The color may sequence between two predetermined colors, which may be selected by the user. To actuate the CONTINUOUS FREEFALL ALERT MODE, button 42 is toggled to an ON position (which is the right-most position depicted in FIG. 4), which causes the programming options in field 44 of the touchscreen to illuminate, and thus, be programmable, whereas the programming options in field 46 become shaded, and are deactivated. The programming options in field 44 includes allowing the user to enter an altitude range associated with the CONTINUOUS FREEFALL ALERT MODE. An upper altitude of the altitude range may be programmed by entering a number into the text field 47. The lower altitude of the altitude range may be programmed by entering a number into the text field 49 in a similar manner.

The color range associated with CONTINUOUS FREEFALL ALERT MODE may also be programmed by selecting a first color associated with the upper altitude and a second color associated with the lower altitude. The first color is selected using slider 48, wherein the user may cycle through the colors of the rainbow and view a preview of the currently selected color in the window 52. The second color is selected using slider 50, wherein the user may cycle through the colors of the rainbow and view a preview of the currently selected color in the window 54. The first and second colors selected by the user may be any color along the color spectrum of the rainbow. It is known that the color sequence of the rainbow may be in the order of red, orange, yellow, green, blue, indigo, and violet (e.g., ROYGBIV). Thus, if the selected colors are red and violet, the visual display 20 may sequence through the entirety of the rainbow during a given jump. However, it is contemplated that the user may select any two colors along the spectrum. Should the user select two adjacent colors on the spectrum, during a given descent, the colors emitted by the visual display 20 may only vary along a small portion of the rainbow spectrum. For example, if a user selects yellow for the upper altitude and green for the lower altitude, the visual display 20 will vary between yellow and green during the descent. In that instance, red, orange, blue, indigo, and violet would not be emitted by the visual display 20.

After the first and second colors are selected, the microcontroller 22 can determine how quickly the color needs to sequence through the spectrum during use. This may be done by identifying the wavelengths associated with the selected first and second colors and a related wavelength differential therebetween. The rate of color change during use may be equal to the wavelength differential divided by the altitude differential. For instance, if the first color selected is red, the wavelength associated with red may be 665 nm, and if the second color selected is blue, the wavelength associated with blue may be 470 nm. As such, the wavelength differential may be equal to 195 nm (i.e., 665 nm-470 nm). Using the example shown in FIG. 4, wherein the upper altitude is 13000 ft. and the lower altitude is 6000 ft., the altitude differential is 7000 ft. (i.e., 13000 ft.-6000 ft.). Therefore, the rate at which the color changes on the visual display is approximately equal to 195 nm/7000 ft., or approximately equal to 2.78 nm/100 ft. These calculations can be conducted by the microcontroller 22 after the altitudes and colors are selected. Furthermore, as the altitude signal is received form the altimeter 24, the microcontroller 22 can vary the control signal for the visual display 20 as the altitude changes.

Although the above example refers to colors in terms of nanometers, it is contemplated that the colors may be referred to in other terms. For instance, the colors may be associated with respective hue values. Along these lines, it is common to assign a range of colors with a hue values ranging from 0-255. Therefore, the calculation for determining a rate of change of color may include determining a hue value differential and dividing that by the altitude differential.

With reference to FIG. 1, when a skydiver uses the altitude display device 10 in the CONTINUOUS FREEFALL ALERT MODE, the visual display 20 may be positioned in the peripheral view of the skydiver. Prior to the jump, the skydiver is aware of the altitude at which he needs to deploy the parachute. This altitude may be preprogrammed as the lower altitude and may be associated with a specific color, as described above. During ascent, the visual display 20 may transition from the second color to the first color, as the skydiver ascents from the lower altitude to the upper altitude. For instance, if the second color is red and the first color is blue, the visual display 20 may transition from red to orange to yellow to green and then to blue once the upper altitude is reached. During the jump, as the skydiver descends and experiences a continuous decrease in altitude, the altimeter 24 may continuously determine the real-time altitude of the skydiver. At the beginning of the jump, assuming the user jumps at or above the upper altitude, the color emitted by the visual display 20 may begin at the color associated with the highest programmed altitude. During the jump, the color emitted by the visual display 20 will appear to continuously blend from the color associated with the highest programmed altitude toward the color associated with the parachute deployment altitude. Continuing with the example of the colors of blue and red being associated with the upper and lower altitudes, respectively, the visual display 20 will appear to continuously blend from blue to green to yellow to orange and finally to red. The blending of colors refers to the visual display 20 making very small, incremental changes in color or hue, in response to very small changes in altitude. As such, the color changes are not large, stepwise changes, wherein the color only makes a handful of steps between the upper and lower altitude. Rather, there may be hundreds or even thousands of incremental colors emitted by the visual display between the selected upper and lower altitudes. For example, as the visual display 20 transitions between blue and red using the example from above, the visual display 20 will display several intermediate hues as the color changes from blue to green, and several intermediate hues as the color changes from green to yellow, and so forth.

Since the skydiver is aware of the preprogrammed colors, and where they may fall in the sequence of rainbow colors, as well as the preprogrammed altitudes, the skydiver can estimate his position between the jump altitude and the parachute deployment altitude based on the current color emitted by the visual display 20. For example, if blue is associated with the jump altitude and red is associated with the parachute deployment altitude, the skydiver may know the colors may sequence from blue to green to yellow to orange and then to red. Furthermore, the skydiver is able to anticipate how much altitude is left between the skydiver' s current altitude and the parachute deployment altitude by comparing the real-time color emitted by the visual display 20 with the color associated with the parachute deployment altitude. If the skydiver knows the parachute deployment altitude is associated with the color red, and the visual display 20 is emitting an orange color, the skydiver may understand that he is rapidly approaching the parachute deployment altitude. Conversely, if the visual display 20 is emitting a green color, the skydiver may know that he is still in the beginning phase of the descent. In this regard, the altitude display device 10 may not simply provide an alert when the parachute deployment altitude is reached; rather, the altitude display device 10 may provide a continuously changing alert signal which may allow the user to approximate his current altitude, as well as estimate how quickly the parachute deployment altitude may be approaching.

While the foregoing describes the sequence of colors being similar to the sequence of colors in a rainbow, it is understood that the scope of the present disclosure is not limited thereto. For instance, the particular sequence of colors may be any color sequence desired by the user.

The apparent continuous blending of color as a result of a change in altitude may be attributable to at least three factors: 1) a refresh rate of the visual display 20, 2) an incremental size of color wavelength of light emitted by the visual display 20, and 3) a sampling rate of the altimeter 24. The refresh rate refers to the rate at which light emitted by the visual display 20 rapidly sequences between on and off. To achieve the perceived continuous on status of the visual display, the visual display 20 may emit the light at a refresh rate that is imperceptible to the user, e.g., the visual display 20 may flash or blink at a rate that may not be detectable by the human eye. In some embodiments this refresh rate may be between 30-90 Hz, and in one particular embodiment is approximately 60 Hz, meaning that the light will turn on 60 times in one second.

With regard to the incremental size of color wavelength of light emitted by the visual display 20, it is understood that in blue-green and yellow wavelengths, a human user may perceive a 1 nm change in wavelength, whereas in longer red and shorter blue wavelengths, a human user may perceive a 10 nm change in wavelength. Therefore, in one embodiment, the change in nanometers between blinks on the visual display 20 may be less than 1 nm, e.g., 0.9 nm. The sampling rate of the altimeter 24 may preferably be at a frequency such that the change in altitude at terminal velocity, e.g., 150-180 mph, does not result in a detected change in altitude between altitude data samples that correlates to a change in nanometers equal to or greater than 1 nm to 10 nm of color change. Preferably, that number would be 1 but could be greater such as 15 or even up to 20 nm.

In the preferred embodiment, the visual display 20 depicts a continuous blending of colors representative of a change in altitude. It is also contemplated that other embodiments may offer a perceptible step wise color change representative of the altitude. By way of example and not limitation, the sampling rate may be slowed down to about 1 or 2 Hz which may sample the altitude once or twice every second. Because of the high terminal velocity of the user and the rate at which the light will change based on the nanometer calculation discussed herein, the incremental size of the wavelength may be greater than the 1 or 10 nanometers depending on the color being depicted. Hence, during use, when the sampling rate is low, the visual display may blink multiple times displaying a wavelength representative of the last sampled altitude. When the altitude is sampled again, a different wavelength is emitted by the visual display. This difference, if more than 1 nm or 10 nm depending on the color being shown, may appear to be stepwise and not a continuous transition.

It is contemplated that in some embodiments the sampling rate may be between 0.5 Hz to 4 Hz. In this range, the refresh rate is preferably greater than the sampling rate so that the most current sampled altitude is represented by the color depicted on the visual display. Although a low sample rate is contemplated, it is preferred that the sample rate and the refresh rate is sufficiently high to achieve a continuous change in color without a blinking effect of the visual display.

Turning now to the DISCRETE FREEFALL ALERTS mode, the DISCRETE FREEFALL MODE may be desirable when the skydiver wants to know when certain altitude thresholds are crossed during a skydive. In this respect, the user may select different color ranges to appear within discrete altitude ranges.

The DISCRETE FREEFALL MODE is actuated by moving button 42 to the off position (e.g., the left-most position in the position as shown in FIG. 4), which causes the options in field 44 to become shaded and not programmable, whereas the programming options located in field 46 become illuminated, and thus, are programmable. The options in field 46 allow a user to set several altitudes at which a defined visual alert or color is illuminated by the visual display 20. In this regard, as the user is falling the user will know when they cross specific altitude threshold(s) by virtue of the visual display 20 depicting the color associated with the specific altitude threshold. The user can program a first altitude alert by actuating a first alert button 56, which allows a user to set the first altitude alert by entering a number into text field 57. The user can program a second altitude alert by actuating a second alert button 60, which allows a user to set the second altitude by entering a number into text field 59. The user can program a third altitude alert by actuating a third alert button 64, and a third altitude text field can be accessed by pulling up the screen using conventional touch screen control finger gestures. The user can program a color for each discrete freefall alert by using sliders 58, 62 associated with the particular discrete freefall alert, and selecting the desired color from the colors of the rainbow. Previews of the currently selected colors associated with the first and second altitude alerts may be displayed in windows 66 and 68.

When skydiving in the DISCRETE FREEFALL MODE, the microcontroller 22 receives the altitude signal from the altimeter 24 and generates a control signal for the visual display 20 based on the programmed alert altitudes and the programmed colors. In one embodiment, the visual display 20 will emit a first color between the first altitude and the second altitude, a second color between the second altitude and the third altitude, and so forth. As such, the color may remain constant when the altitude is between two defined thresholds. In another embodiment, the visual display 20 may continuously transition the colors between the first color and the second color as the altitude changes from the first altitude and the second altitude, and transition the colors between the second color and the third color as the altitude changes from the second altitude to the third altitude and so forth. For instance, if the first color is red, the second color is violet, and the third color is yellow, the visual display 20 may blend from red to orange, to yellow, to green, to blue, to indigo, and finally to violet as the altitude changes from the first altitude to the second altitude. The colors may then blend from violet to indigo, to blue, to green, and then finally to yellow as the altitude changes from the second altitude to the third altitude.

In some instances, the altitude ranges may not be adjacent to one another. For instance, one range may be from 18000 ft. (e.g., first altitude) to 10000 ft. (e.g., second altitude), and then another range may be from 9999 ft. (e.g., third altitude) to 6000 ft. (e.g., fourth altitude). The colors associated with each altitude may be red (e.g., first color), green (e.g., second color), yellow (e.g., third color) and violet (e.g., fourth color). Therefore, as the user descends within the first range, the light emitted by the visual display 20 may blend from red to orange to yellow and then finally to green. As the user quickly transitions from the first altitude range, ending at 10000 ft., to the second altitude range, starting at 9999 ft., the visual display 20 may transition from green to yellow. This transition between altitude ranges may occur in several different ways. Any gap between altitude ranges may result in the visual display 20 either: 1) going dark; 2) remaining the color associated with the second altitude; 3) being emitted as the color associated with the third altitude; 4) blending between the colors associated with the second and third altitudes; or 5) illuminate at some other color. Since the DISCRETE FREEFALL MODE may be used to identify specific altitude ranges, it may be preferred for the visual display 20 to go dark (i.e., turn off) within any gap between altitude ranges, or illuminate some color not specifically defined with an altitude range, such as being illuminated as white light. This preference may be made by the user and programmed into the control unit 14, or alternatively, the control unit 14 may have a default setting which executes one of the aforementioned options.

Calculations regarding the change of the color may be calculated as described above, wherein a wavelength (or hue) differential is calculated along with an altitude differential, and the color change being equal to the wavelength differential divided by the altitude differential.

In the above described operational modes, the user may program an exit altitude into the control unit 14. This may be the highest altitude programmed into the control unit 14. However, it is contemplated that in other embodiments, the exit altitude is automatically determined by detecting a rapid change in altitude, which may be associated with the skydiver exiting an aircraft, or jumping from another elevated structure. When the exit altitude is automatically determined, the skydiver may select a lower altitude, as well as a first color associated with the exit altitude and a second color associated with the lower altitude. Therefore, when the exit altitude is detected, the microcontroller can determine the altitude range, as being equal to the difference between the detected exit altitude and the lower altitude, and calibrate the selected color range defined by the first and second colors to the altitude range.

The altitude display device 10 may also be operable in a CANOPY MODE, which provides a visual alert once the parachute is deployed and the user is more gently falling toward a landing zone. In the CANOPY MODE, the microcontroller 22 may automatically detect a rapid decrease in speed (e.g., derived from a smaller altitude decrease over a given period of time), which is an indication that the parachute has deployed. The transition from the CONTINOUS FREEFALL ALERT MODE or DISCRETE FREEFALL ALERT MODE to the CANOPY MODE may be implemented automatically by the microcontroller 22, independent of any user input. The altitude at which the rapid decrease in speed is detected may be referred to as a deployment altitude, which defines a canopy altitude range. The user may select colors associated with the deployment altitude, and the landing altitude, such that the microcontroller calibrates the selected color range with the deployment altitude. Thus, as the user gently falls with the parachute deployed, the visual display 20 may continuously transition the emitted color along the selected color range.

In any of the modes associated with a change in altitude, the altitude display device 10 may be programmed to generate a flashing signal at a particular altitude. The particular altitude associated with the flashing signal may be an altitude that a skydiver should track away from a group, or the skydiver is nearing the ground.

Although the foregoing describes the visual display 20 as providing a visual alert corresponding to a change in altitude, it is contemplated that in another operational mode, the visual display 20 may provide a visual alert corresponding to the vertical descent speed of the user. Being able to approximate speed while skydiving may be useful during an angle track jump, wherein a skydiver tries to identify how his vertical descent speed may change in response to a change in the angle of his track. The vertical descent speed may be calculated by the microcontroller 22 by dividing a change in altitude by a change in time. As such, the microcontroller 22 may be in communication with a timing circuit to provide the time data necessary to make such calculations.

The user may be able to program the control unit 14 to operate the visual display 20 such that the visual display 20 transitions or blends the emitted color within a defined color spectrum. Along these lines, the user may select an upper speed and a first color associated with the upper speed, and a lower speed and a second color associated with the lower speed. As such, as the speed varies between the upper speed and the lower speed, the visual display 20 continuously transitions between the first speed and the second speed.

Programming of the microcontroller 22 may also allow the user to select whether the visual display signal is associated with the speed, or altitude. In one particular, embodiment, the microcontroller 22 may be programmed such that the visual display 20 depicts a signal associated with speed within a first altitude range, and then the visual display 20 depicts a signal associated with altitude within a second altitude range. For instance, at the beginning of a jump, the user may be interested in receiving speed information, and thus, the visual display 20 may be associated with the speed of the skydiver. However, once a certain altitude threshold is crossed, the microcontroller 22 may automatically transition to associating the visual display 20 with altitude. The user may select the colors associated with speed and altitude, such that a change in the color spectrum will alert the user that the defined altitude threshold has been crossed. For instance, the color spectrum associated with speed may vary from yellow to orange, whereas the color spectrum associated with altitude may vary from purple to blue. Thus, when the visual display 20 transitions from orange to purple, the user will know the defined altitude threshold has been crossed.

It is contemplated that the control unit 14 may include a memory circuit 37 for storing data generated during use. For instance, altitude data generated by the altimeter 24 may be stored in the memory circuit 37. The selected color range(s) may also be stored in the memory circuit 37, along with their respective altitude range(s). Furthermore, the user's speed during the jump may also be stored in the memory circuit 37. The data stored in the memory circuit 37 may be stored for a number of jumps. A user may access the data stored in the memory circuit 37 through the wireless circuit 28 or through another data access port that may be formed on the control unit 14.

In addition to being mountable on a helmet 12, as shown in FIG. 1, it is also contemplated that in other embodiments, the visual display 20 may be integrated with the control unit 14 into a single unit which may be chest-mounted or wrist-mounted. Such a single unit may or may not include an additional numeric display of altitude. Along these lines, a chest-mounted altitude display device may be preferred for someone performing a skydive wearing a wingsuit. In a single integrated unit, the visual display may include a light strip, wherein a change in altitude may not also result in a change in color emitted by the visual display, the change in altitude may also change the position of the light emitted on the light strip. For instance, the highest altitude may be associated with one end of the strip, while the lowest altitude may be associated with the other end of the strip, and the emitted light signal may continuously travel from one end of the strip to the other throughout the skydive. Furthermore, it is also contemplated that the altitude display device 10, or various components thereof, such as the control unit or the display unit may be mounted or integrated directly into the helmet or other headwear worn by the user, such as goggles.

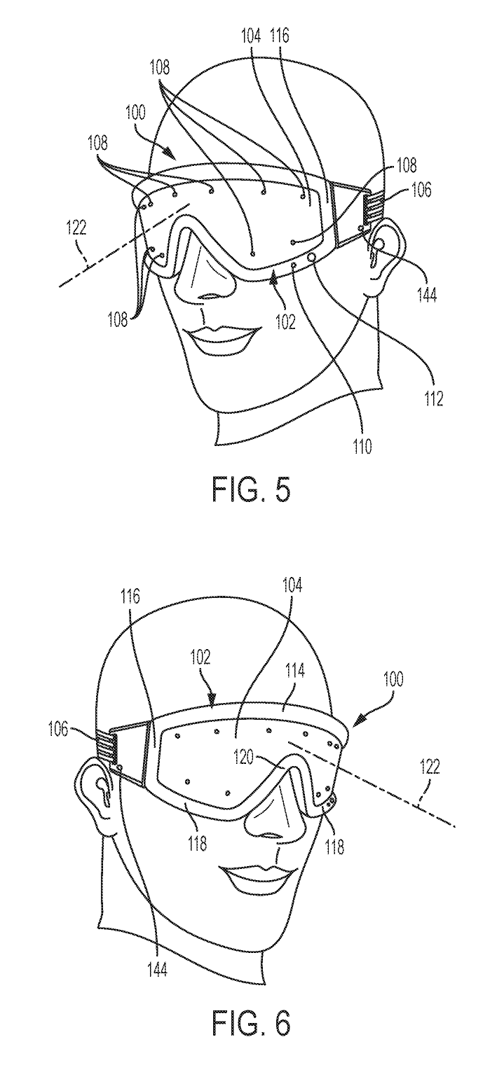

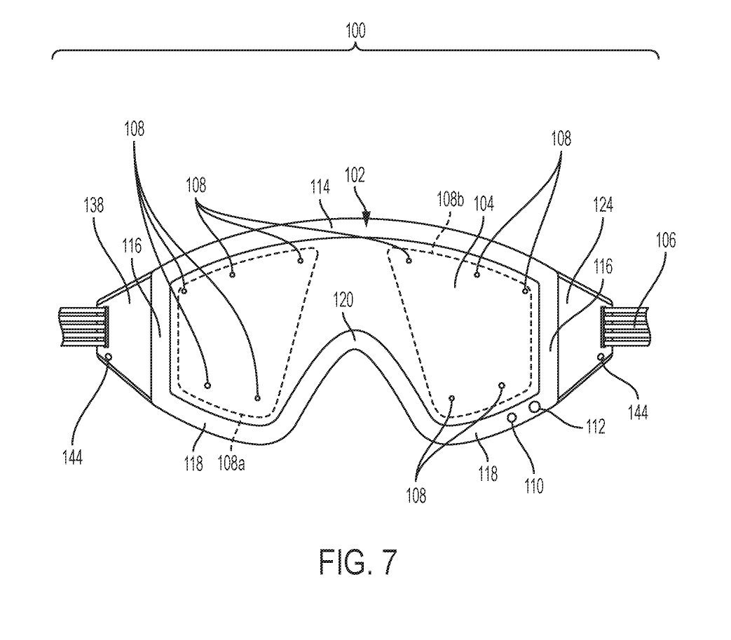

Referring now to FIGS. 5 and 6, there is depicted an eyewear device 100 wearable by a user for providing critical visual and audible alerts to a user during aviation activities, e.g., skydiving, BASE jumping, paragliding, hang gliding, aircraft piloting, etc. The eyewear device 100 may be configured similar to goggles, and may generally include an eyewear frame 102 (see FIG. 5), a lens 104 (see FIG. 6) connected to the eyewear frame 102, and a strap 106 connected to the eyewear frame 102 for securing the eyewear device 100 to the user's head. The eyewear device 100 may additionally include a plurality of lights 108 (see FIG. 5) positioned within the user's field of view, such that the lights 108 may provide directional guidance to the user by emitting certain light characteristics associated with directional commands. For instance, the lights 108 may be arranged into two groups, i.e., a left group 108a (see FIG. 7) and a right group 108b, such that lights 108 on one side may illuminate a certain color to guide the user in that direction. The plurality of lights 108 may also provide altitude information to the user by sequencing through a known color range as the altitude of the user changes.

The directional information provided by the eyewear device 100 may guide the user to a particular location or target. For instance, when skydiving, there may be a particular landing location to which the skydiver may have to navigate. If the skydiver is looking toward the target location, the plurality of lights 108 may illuminate a common color, e.g., red. However, if the target location is to the left of where the skydiver is looking, the lights 108a on the left side of the device 100 may illuminate as one color, e.g., green, while the lights 108b on the right side of the device 100 may illuminate as another color, e.g., red. The green lights 108 may provide an indication to the user to turn his head to the left. As the user turns his head to the left, the green lights 108 may turn another color, e.g., red, when the user's line of view aligns with the preferred directional heading associated with the desired target. As such, the direction the user's head is facing when the green lights 108 transition back to red may be the direction of the desired target. Conversely, if the target location is to the right of where the skydiver is looking, the lights 108b on the right side of the device 100 may illuminate as green, while the lights 108 on the left side of the device 100 may illuminate as red.

The frame 102 may define a central opening which is covered by the lens 104, such that the frame 102 may provide structural support to the lens 104. The frame 102 may be flexible to allow the frame 102 to generally conform to the contour of the user and enhance the comfort of the device 100 during use. The frame 102 may completely circumnavigate the opening, or alternatively, the frame 102 may only partially circumnavigate the opening. The frame 102 may include respective openings or recesses for an electret microphone 110 and an ambient light sensor 112, which may be coupled to the frame 102, as will be described in more detail below.

The frame 102 may be contoured to accommodate the facial features of the user. In this regard, the frame 102 may include an upper segment 114 (see FIG. 6) which extends across a lower portion of the user's forehead during use. A pair of lateral segments 116 may extend from opposite ends of the upper segment 114. The frame 102 may additionally include a pair of lower segments 118, wherein each lower segment 118 extends from a respective lateral segment 116. The frame 102 may further include a bridge section 120 that extends up and over the user's nose between the pair of lower segments 118.

The lens 104 may be connected to the frame 102 so as to completely extend over the central opening of the frame 102. The lens 104 may be disposed about a central axis 122, which may be representative of a viewing axis when the lens 104 is worn by the user. The lens 104 may define a curvature or arcuate shape so as to allow the lens 104 to extend across the user's face. The lens 104 and frame 102 may be configured such that when the eyewear device 100 is worn by the user, the lens 104 is spaced from the user's eyes so as to mitigate any discomfort when the user blinks his eyes. The lens 104 may be made of clear ballistic polycarbonate with a thickness of 2.25-2.75 mm, and more preferably, 2.6 mm, with a preferred minimum thickness of 2.5 mm at a recession for a flexible printed circuit board, as will be explained in more detail below. The lens 104 may conform to various safety standards, such as American National Standards Institute (ANSI) Z87.1 (2015) and MIL PRF 32432 (i.e., Military Ballistics Standard).

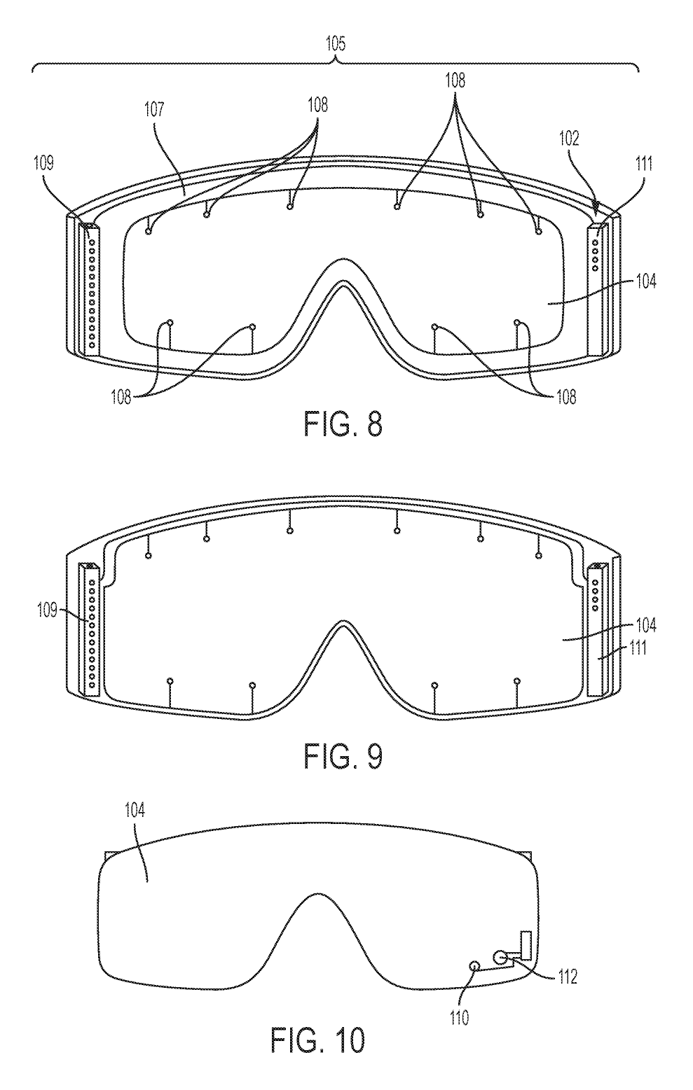

FIG. 8 is a rear view of a lens assembly 105 including the lens 104 attached to the frame 102. Foam padding 107 may be adhered to the inside of the lens 104 for user comfort and to protect the user's eyes from wind and debris. Conductive wires are shown, which connect the lights 108 to a control unit 124, described in more detail below. A 13-pin male connector may be included on one side of the lens assembly 105 and a 4-pin male connector may be included on the other side of the lens assembly 105.

FIG. 9 is a rear view of the lens 104, with the frame 102 removed therefrom. As can be seen, wiring for electrical and power signals may be routed adjacent a periphery of the lens 104, and may be covered by the frame 102 to conceal as much of the wiring from the user as possible.

The lights 108 included in the eyewear device 100 may include ten surface-mount device light emitting diode modules, i.e., SMD RGB LEDs (APA102-2020). The LEDs 108 may be mounted on a clear, flexible printed circuit board (PCB), which may be adhered to an inside surface of the lens 104 using an adhesive. An exemplary adhesive may be 300LSE clear laminating adhesive in 2 mil thickness, sold by 3M. The PCB may be placed in a small recess formed in the lens 104 that is complimentary in shape to the PCB. In one embodiment, the recess has a depth of 0.5-0.2 mm, and more preferably 0.1 mm. The PCB may be manufactured to minimize its surface area to maximize visibility through the lens 104. The LEDs 108 may be small, such as 2×2 mm, so as to minimally obscure peripheral vision through the lens 104. In the exemplary embodiment, the eyewear device 100 includes six LEDs 108 positioned adjacent the upper segment 114 of the frame 102, and four LEDs 108 positioned adjacent the lower segments 118.

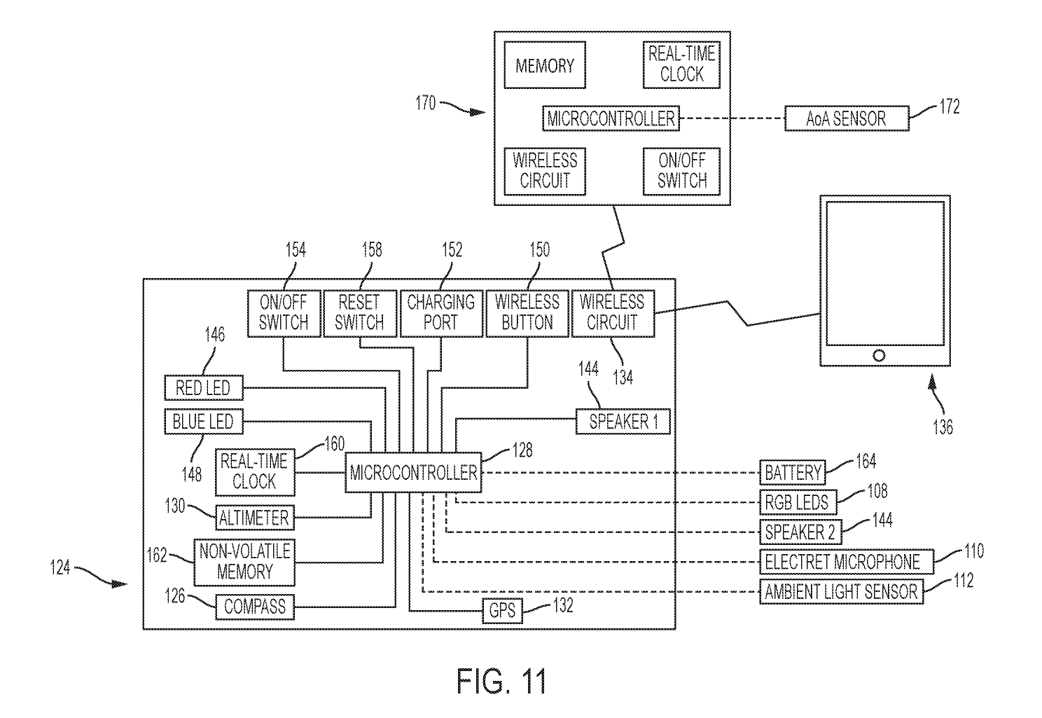

Operation of the LEDs 108 may be controlled by a control unit 124 (see FIG. 11), which may be connected to the frame 102. The control unit 124 may include the hardware and software necessary to detect the desired positional data of the eyewear device 100 for implementing the desired functionality on the eyewear device 100. Along these lines, the control unit 124 may include a compass 126 to detect a directional heading of the eyewear device 100. The compass 126 may be a digital compass that may include a magnetic sensor that detects differences in the Earth's magnetic field for purposes of detecting a directional heading. The magnetic sensor may be configured to such that the axis of detection corresponds to the central axis 122 of the lens 104 (e.g., the viewing axis of the user), such that when the heading of the lens 104 moves, the magnetic sensor may detect the changed heading. The compass 126 may be in communication with a microcontroller 128 so as to allow the microcontroller 128 to receive heading signals generated by the compass 126. The microcontroller 128 may be a SAM D20 ARM® Cortex®-M0+ sold by MICROCHIP TECHNOLOGY.

The control unit 124 may additionally include an altimeter 130 for detecting an altitude of the eyewear device 100 and generating an altitude signal representative of the detected altitude. The altimeter 130 may be in communication with the microcontroller 128 so as to allow the microcontroller 128 to receive the altitude signals generated by the altimeter 130. An exemplary altimeter 130 may include the BMP388 barometric pressure sensor sold by BOSCH SENSORTEC.

The control unit 124 may further include a GPS circuit 132 to detect the position of the eyewear device 100. The position information detected by the GPS circuit 132 may be used to determine the position of the user wearing the eyewear device 100 relative to a target location. In this regard, the GPS circuit 132 may simply generate coordinate data, i.e., latitude and longitude information, while the compass 126 and altimeter 130 may detect heading information and altitude information. However, in other embodiments, the GPS circuit 132 may be capable of detecting altitude, heading information and directional information, in which case, the compass 126 and the altimeter 130 may not be necessary. The GPS circuit 132 may be in communication with the microcontroller 128 so as to allow the microcontroller 128 to receive the GPS signals generated by the GPS circuit 132.

The control unit 124 may additionally include a wireless circuit 134 which may allow the microcontroller 128 to communicate with one or more remote electronic devices, such as a smartphone 136, tablet computer, external sensors, external controllers, etc. The ability of the control unit 124 to communicate with a remote device may be particularly useful when programming the control unit 124 prior to a particular aviation activity or downloading data after a particular aviation activity. For instance, a particular target location may be preprogrammed into the control unit 124 prior to a skydive, such that the control unit 124 may use the preprogrammed information to generate the operational signals for the LEDs 108.

The microcontroller 128 may generate light control signals based on the information received from the compass 126, altimeter 130, and GPS circuit 132, as well as any preprogrammed information that may be stored in the microcontroller 128. In this regard, the microcontroller 128 may be in communication with the LEDs 108 to facilitate transmission of the generated light control signals from the microcontroller 128 to the LEDs 108. The light control signal may control the color of the light emitted by the LEDs 108, as well as the frequency that the LEDs 108 may blink, or not blink.

The microcontroller 128 may be in communication with an ambient light sensor 112, which may monitor the ambient light conditions and communicate an ambient light signal to the microcontroller 128. The ambient light sensor may be mounted on the frame 102 or lens 104. The microcontroller 128 may be operative to adjust the brightness of the LEDs 108 based on the detected ambient light conditions. For instance, the brightness of the LEDs 108 may be brighter in bright ambient light conditions, and darker in dark ambient light conditions. The ambient light sensor 112 may be a TEMT6000X01 ambient light sensor sold by VISHAY INTERTECHNOLOGY, INC.

The control unit 124 may be in communication with the electret microphone 110 or other microphones known in the art, which may be used to monitor the ambient sound level for adjusting the volume of the speakers 144 accordingly. The electret microphone may be mounted on the frame 102 or lens 104. The electret microphone 110 may communicate an ambient sound signal to the microcontroller 128, which may be operative to adjust the volume of the speakers 144 based on the ambient sound signal. The electret microphone 110 may be a CMC-4015-130T microphone manufactured by CUI Inc.

The ambient light sensor 112 and electret microphone 110 may be wired to the control unit 124 via a flexible PCB, which may be adhered to the lens 104 and positioned between the lens 104 and the frame 102.

The control unit 124 may additionally include a real-time clock 160 and a memory module 162, which may include non-volatile memory. The real-time clock 160 may be a MAXIM INTEGRATED DS3231 real-time clock. The memory module 162 may be an ADESTO TECHNOLOGIES AT25SF081-SSHD-T flash drive. The memory module 162 may be operative to store directional data, altitude data, time data, location information, user profile information, etc. Such data may be recalled from the microcontroller 128 to implement the functionality of the eyewear device 100, or the data may made available for transfer to another device.

During use, such as skydiving, a user may place the eyewear device 100 on the user's head, with the frame 102 and lens 104 positioned over the user's eyes, such that the lens 104 extends within the user's field of view. During a skydive, a user may be carried in a aircraft from ground level, to a higher altitude, where the user may jump from the aircraft to begin the skydive. During the ascent in the aircraft, the eyewear device 100 may be in an ascent mode, wherein certain functionalities are disabled. For instance, the LEDs 108 may be off in the ascent mode, although the altimeter 130, GPS circuit 132, and compass 126 may be operable to send information to the microcontroller 128 to track the entire trip from takeoff to landing. Alternatively, a user may desire to receive visual alerts from the LEDs 108 during ascent, such as altitude alerts. Therefore, the color of light emitted by the LEDs 108 may change as the aircraft ascends to visually depict the change in altitude.

When the user jumps from the aircraft, the sudden drop by the user may be reflected in data communicated to the microcontroller 128 by the altimeter 130 or GPS circuit 132, alerting the microcontroller 128 that the skydive has begun. This may automatically transition the microcontroller 128 from the ascent mode to an active mode, wherein the LEDs 108 are activated or alternatively, the LEDs 108 may transition from displaying signals based on one set of data (e.g., altitude data) to another set of data (e.g., directional data). When the LEDs 108 are activated, the color of the LEDs 108 may guide the user toward the desired target location, such as a landing location. The LEDs 108 may be grouped into the left group 108a and the right group 108b. When the user is looking toward the target location, and the viewing axis, represented by central axis 122, is substantially aligned with the target location, all of the LEDs 108 may be red, thereby notifying the user to stay on track, and that no change in heading is required. However, should the viewing axis fall out of alignment with the target location, one of the light groups may be green to guide the user in that direction. For instance, if the viewing axis is too far to the right of the target location, then the left group of LEDs 108a may turn green to guide the user to the left. Conversely, if the viewing axis is too far to the left of the target location, then the right group of LEDs 108 may turn green to guide the user to the right. The left or right group of LEDs 108 may stay green until the viewing axis is aligned with the target location.

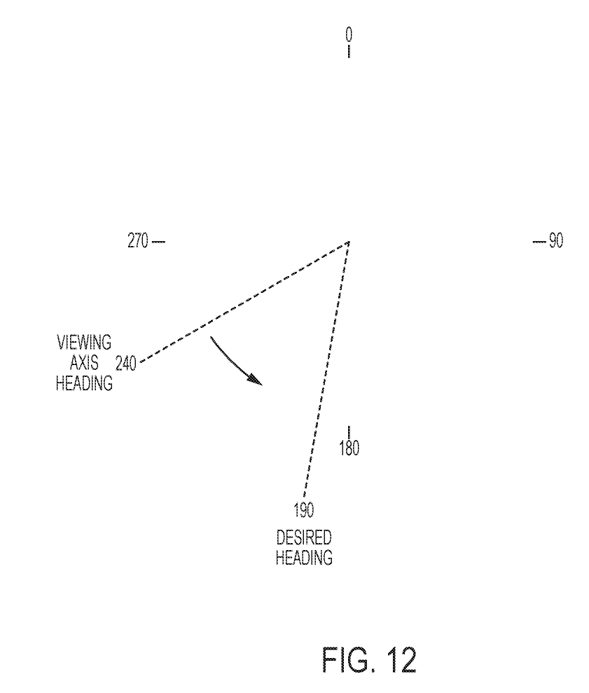

The heading signals from the compass 126 and/or GPS circuit 132 may be used by the microcontroller 128 to generate the light command signals to provide guidance to the user. The heading signals may be compared to a desired heading to determine a heading differential. For instance, referring to FIG. 12, if the desired heading is 190 degrees (with North being 0 degrees, east being 90 degrees, south being 180 degrees, and west being 270 degrees), and the heading signal indicates that the viewing axis is 240 degrees, the microcontroller 128 may determine that the viewing axis is 50 degrees out of alignment to the right of the desired heading. As such, the microcontroller 128 may generate control signals to turn the left group of LEDs 108a green.

There may be an acceptable range of directional headings which the microcontroller 128 may recognizes as being aligned with the target heading. For instance, the acceptable range of directional headings may be +/−10 degrees from the target heading, more preferably +/−5 degrees from the target heading, and still more preferably +/−2 degrees from the target heading.

The eyewear device 100 may provide the guidance information to the user from the time the user exits the aircraft until the time the user lands on the ground. Thus, the user may be provided with continuous heading information throughout the sky. The location of the LEDs 108 within the user's field of view may allow the user to easily view the heading information without taking the user's attention away from the user's surroundings.

In addition to, or as an alternative to the heading guidance functionality described above, the eyewear device 100 may provide altitude information to the user during an aviation activity. The altitude information may be conveyed to the user through changes in color of the light emitted by the LEDs 108. In this respect, the altimeter 130 and LEDs 108 may function similar to the altimeter 130 and light source described above in relation to the altitude display device. The LEDs 108 may emit light having a color correlated to a particular altitude. Accordingly, while the user is skydiving and experiencing a continuous change in altitude, the color of the LEDs 108 may continuously sequence through the colors of the rainbow. The change in color of the LEDs 108 may appear to be continuous or uninterrupted to the skydiver by blending the color at a refresh rate that is imperceptible to the skydiver, e.g., greater than the average eye can detect, such as greater than 30-60 Hz.

It is contemplated that the eyewear device 100 may be capable of simultaneously conveying directional information and altitude information to the user through the light emitted by the LEDs 108. For instance, a change in color emitted by the LEDs 108 may represent a change in altitude, while direction guidance may be represented by blinking LEDs 108. If the left group of LEDs 108a blinks, then the user may be guided to the left, whereas if the right group of LEDs 108b blinks, then the user may be guided to the right.

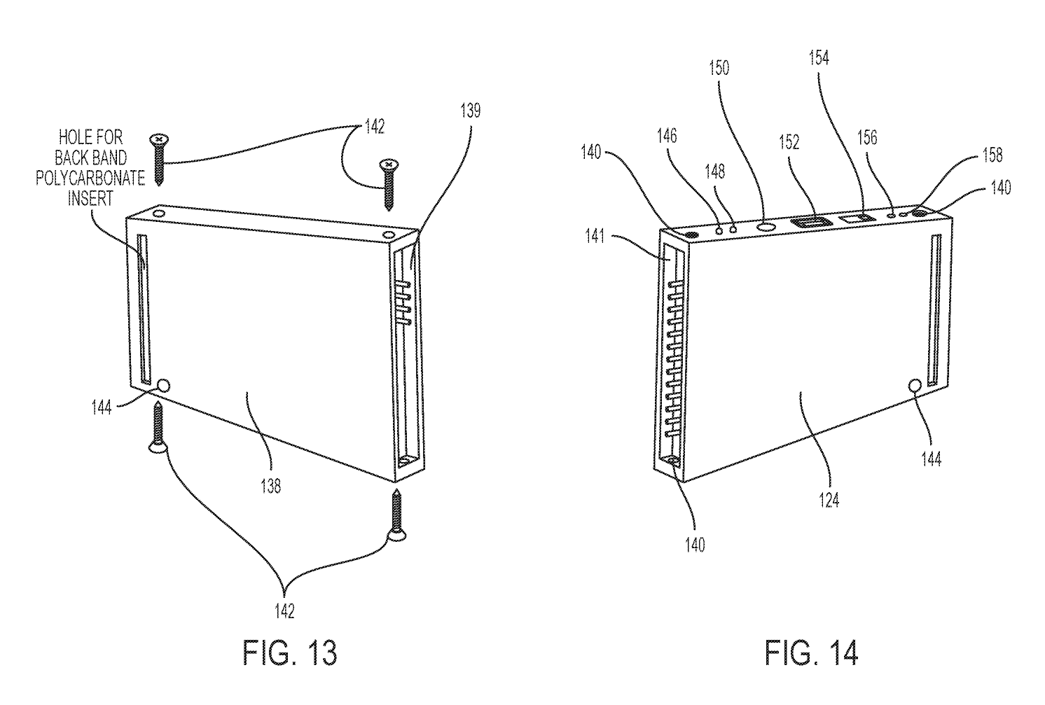

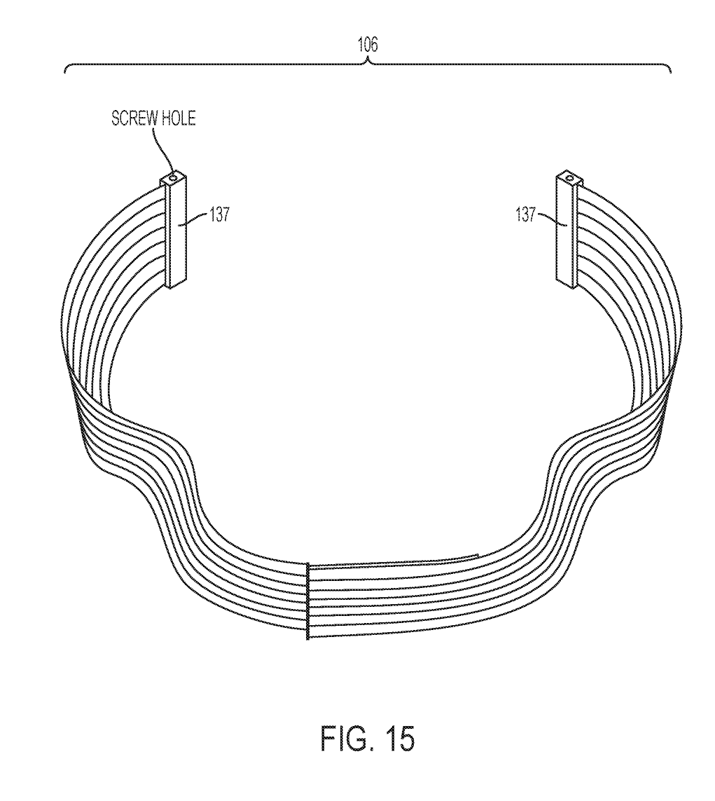

Referring now to FIGS. 13 and 14, there is depicted a battery housing 138 and control unit 124, respectively, which may be connected to the frame 102, such that the LEDs 108 are in communication with the battery housing 138 and control unit 124 to receive power and control signals therefrom. The battery housing 138 may contain a rechargeable battery 164, such as a lithium polymer battery. The battery housing 138 and the control unit 124 may both include clamshell-type cases that may be made of opaque ballistic polycarbonate, having a wall thickness of between 1.0-2.0 mm, and more preferably 1.5 mm. Both the battery housing 138 and the control unit 124 may include multiple screw holes 140 to receive screws 142 for holding the lens 104, control unit 124, battery housing 138, and the strap 106 together. The lens 104, the control unit 124, the battery housing 138, and the strap 106 may be modular so that any single component can be switched out. The battery housing 138 and control unit 124 may connect to the frame 102 via custom male-female connectors 139, 141. The battery housing 138 and control unit 124 may also both include a quadrangular hole or slot to receive a polycarbonate insert 137 for securing the strap 106 to the battery housing 138 and the control unit 124.

The control unit 124 and the battery housing 138 may include complementary piezo speakers 144, which may be located in opposed relation to each other when worn by the user, and in close proximity the user's ears. The piezo speakers 144 may emit audible signals to the user, such as alerts regarding altitude, heading, or instructions during an aviation activity, such as instructions for deploying a parachute.

The control unit 124 may further include a red LED 146, and a blue LED 148. The red LED 146 may indicate a battery charging status, with the red LED 146 turning green when fully charged. The blue LED 148 may illuminate when the device 100 is in a wireless communication mode, e.g., BLUETOOTH® mode, which may allow the device 100 to receive data from an external controller or allow a user to program the device 100 through a smartphone app. A wireless communication button 150 may be actuated for a predefined period of time, e.g., 5 seconds, to transition the device 100 into the wireless communication mode.

The control unit 124 may include a charging port 152, such as a USB port, for charging the device 100. The charging port 152 may be a MOLEX 105443 port. The control unit 124 may additionally include an ON/OFF switch 154 to allow a user to selectively transition the device 100 between ON and OFF modes of operation. A pinhole 156 may be formed in the control unit 124 to provide ventilation, which may be necessary for a barometric altimeter 130 in the control unit 124. A reset button 158 may be used to reset the microcontroller 128 in the control unit 124 in the event the device 100 operates in an unexpected operational mode.

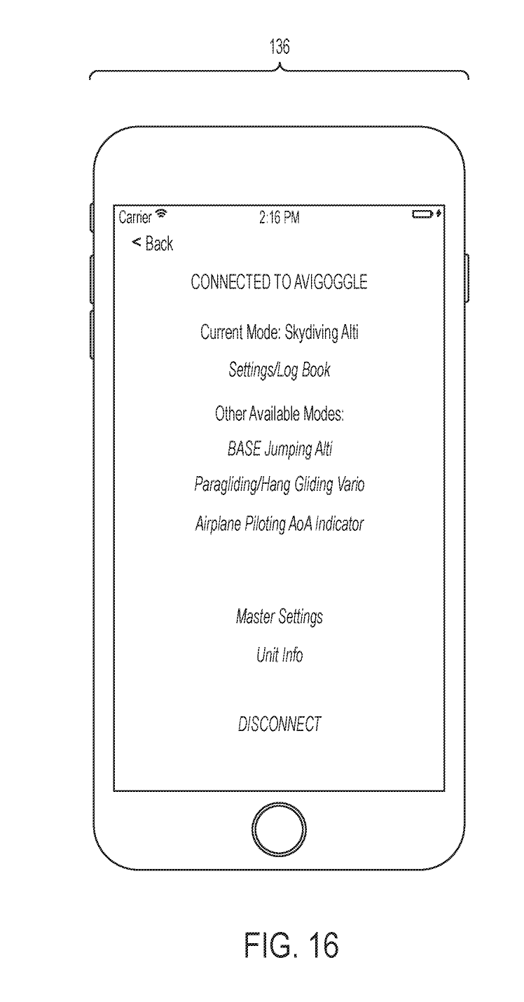

Referring now to FIG. 16, a schematic view of a smartphone 136 is shown, with the smartphone 136 having an application stored thereon to allow a user to program the eyewear device 100. At the top of the screen, the name of the device to which the smartphone 136 is connected, i.e., AVIGOGGLE, is displayed. The current mode of the device, i.e., Skydiving Alti, is also displayed. The mode of the device may be set by clicking on the “Settings/Log Book” button. The eyewear device 100 may be used in four modes, namely, Skydiving Alti, BASE Jumping Alti, Paragliding/Hang Gliding Vario, and Airplane Piloting AoA Indicator. For the Skydiving Alti, BASE Jumping Alti, Paragliding/Hang Gliding Vario modes, the eyewear device 100 may function on its own, while in the Airplane Piloting AoA Indicator mode, an external device may interface with the eyewear device 100, such that the external device may function as a master device, and the eyewear device 100 may function as a slave device. In that mode, both the master device and the slave device may be controllable by the same smartphone app. Once the master and slave devices are configured and disconnected from the app, the external master device may continuously send AoA data to the eyewear device 100. Overall light and volume settings, such as whether volume and brightness are automatically adjusted, may be changed under “Master Settings.” The “Unit Info” button may display information about the eyewear device 100, such as a serial number, battery status, and date of manufacture.

When used as an altimeter 130 in “Skydiving Alti” mode, the device may be capable of emitting light of predefined colors in predefined altitude ranges. The user may set the device on the ground before engaging in skydiving activities. One may be able to set five altitude ranges for freefall, four for canopy, and two for ascent in the aircraft, each with a chosen color to be displayed by the LEDs 108. When on passes through the indicated altitude in freefall or under canopy, the LEDs 108 may display the solid color continuously until the jumper reaches the next indicated altitude, at which point the next color may be displayed continuously. Ascent alerts may be displayed as a series of 8 short flashes.

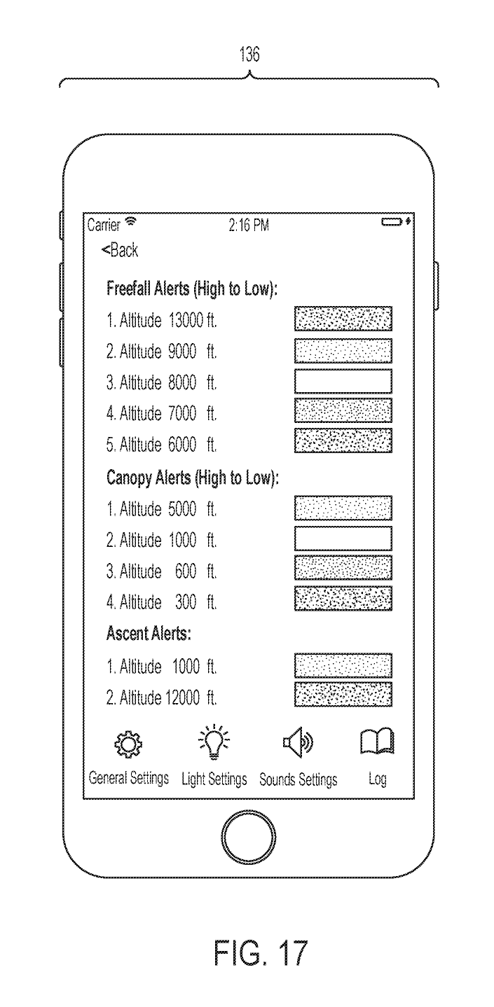

FIG. 17 shows a screen of the smartphone app for setting lights of various colors to appear in freefall. To set the color of the alerts, a user may tap the preview window to open up a color-picker, which may also allow a user to preview the colors on the eyewear itself. Leaving an altitude field blank may disengage that alert. Similarly, the device may be configured to sound predefined alarms at predefined altitude thresholds, with the same number of alarms being available for freefall, canopy, and ascent. When a user passes through the indicated altitude in freefall, the chosen sound may continually play until the next indicated altitude is reached. Under canopy and during ascent, alarms may be played for 2 seconds at the indicated altitude(s).

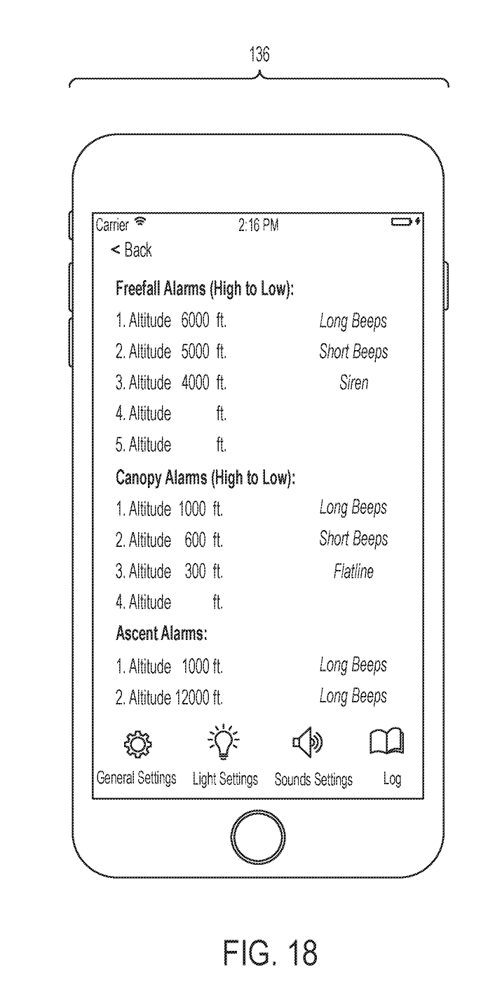

FIG. 18 shows a screen of the smartphone app for setting various alarms to sound during freefall. To change the sound, a user may tap the current sound and a pop-up menu may allow a user to select a different sound. Leaving an altitude field blank may disengage that alarm.

The eyewear device 100 may provide several advantages to those participating in aviation activities. The integration of LED indicators and speakers into eyewear may allow the user to wear less gear. Furthermore, the device 100 may automatically adjust the brightness of the LEDs 108 and the volume of the speakers based on the constantly changing environment during a skydive. Furthermore, the indicators given by the device may be visible and audible, regardless of the direction a skydiver may be looking.

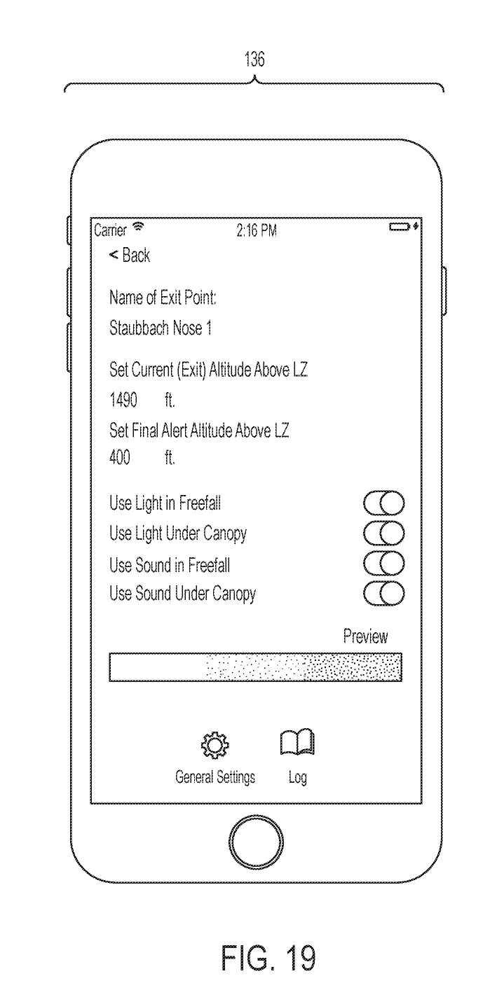

When the eyewear device 100 is used in BASE Jumping Alti mode, the device may be capable of emitting colors and sound patterns that indicate a user's current altitude. FIG. 19 shows a screen of a smartphone app for setting the eyewear device 100 for BASE jumping. The user may set the eyewear device 100 at the exit point by entering the device's current altitude above the intended landing zone. The user may then set a second final alert altitude above the landing zone, with the second final alert altitude being associated with the altitude at which the user may want to be alerted to pull the parachute. The user may select a color from the HSV color model that may coincide with the exit altitude (e.g., 180 degrees) and a color that coincides with the final alert altitude (0 degrees).

When the user jumps with the eyewear device 100 from the exit point, the LEDs 108 on the device may be illuminated with a color corresponding to the current altitude, starting with the color that coincides with the exit altitude and then blends through the colors of the HSV color spectrum until they reach the final alert color (e.g., from 180 degrees to 0 degrees). When the final alert is reached, the device may rapidly flash (e.g., 4 flashes per second) to indicate that the critical altitude has been reached, thus alerting the user to deploy the parachute. Upon detecting an open canopy, the device may cycle through the same colors (e.g., from 180 degrees to 0 degrees), beginning with the color that corresponds to the exit altitude and blending through the same colors until the landing zone altitude is reached, with the color corresponding to the final alert altitude.

In addition to emitting light, the eyewear device 100 may be configured to emit sound during a BASE jump. When a user jumps from the exit point, 4 kHz square-wave pulses may be heard that increase in frequency as the user approaches the final alert altitude, at which point the user may hear a flatline 4 kHz square wave. Lights and sound may be configured to turn off or on in freefall or under canopy.

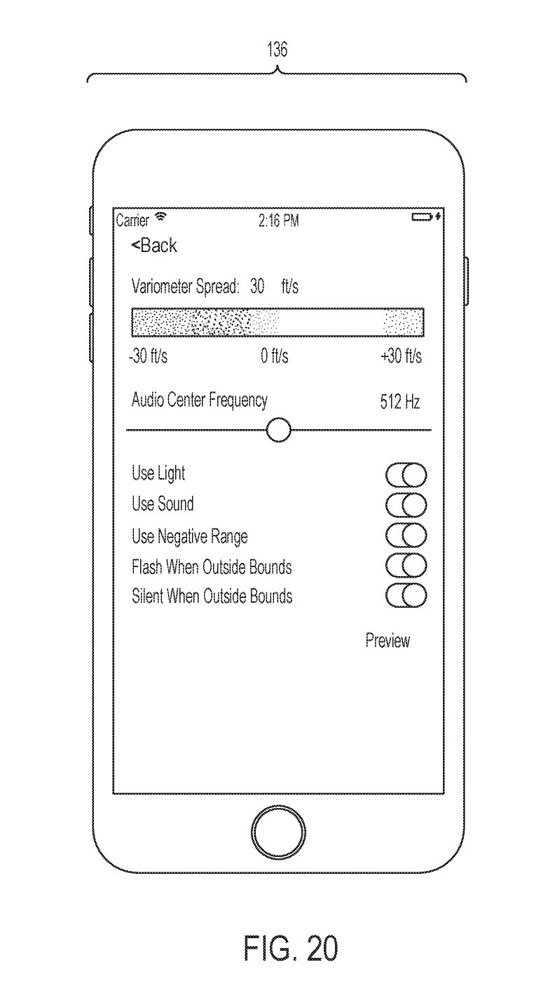

When used as a variometer in “Paragliding/Hang Gliding Vario” mode, the device may be capable of emitting colors and sound patterns that indicate whether the user is climbing or sinking. The device may be set on the ground or while paragliding or hang gliding. The user's ascent rate is indicated by the colors in the HSV color model, in which hue may be represented in degrees. Cyan, which lies in the center of the HSV color model at 180 degrees, may represent a climb rate of 0 ft/s. Hues less than 180 degrees may represent an increasing climb with decreasing value, and hues greater than 180 degrees may represent an increasing sink with increasing value. A user may set the range of the variometer at the top of the smartphone screen depicted in FIG. 20. Some paragliders and hang gliders may only like to make use of the climb indicator, so a user may optionally turn off the negative range of the variometer. The center frequency of the audio indicator, i.e., the frequency representing a climb of 0 ft/s, may be set by the user. When ascending, the device may emit a short, e.g., 0.2 second, square wave pulse once per second that rise in pitch with increasing ascent rate. When descending, the device may emit a steady, e.g., flatline, square wave having a pitch which decreases with decreasing ascent rate. The audible interval corresponding to 1 ft/s at which the pitch shall vary may be 1/10^{th} of a half step. If the center pitch is set to 512 Hz, a descent rate of 30 ft/s may be represented by a frequency of 430.5 Hz. The device may also be set to no display any light or sound when under a certain ascent or descent rate, such as 3 ft/s.

According to another aspect of the present disclosure, the eyewear device 100 may be worn by a pilot flying an aircraft to provide flight information to the pilot. For instance, the LEDs 108 may function as an angle of attack (AoA) indicator, such that the light emitted by the LEDs 108 may transition in color between two known colors, such as green and red, to indicate AoA.

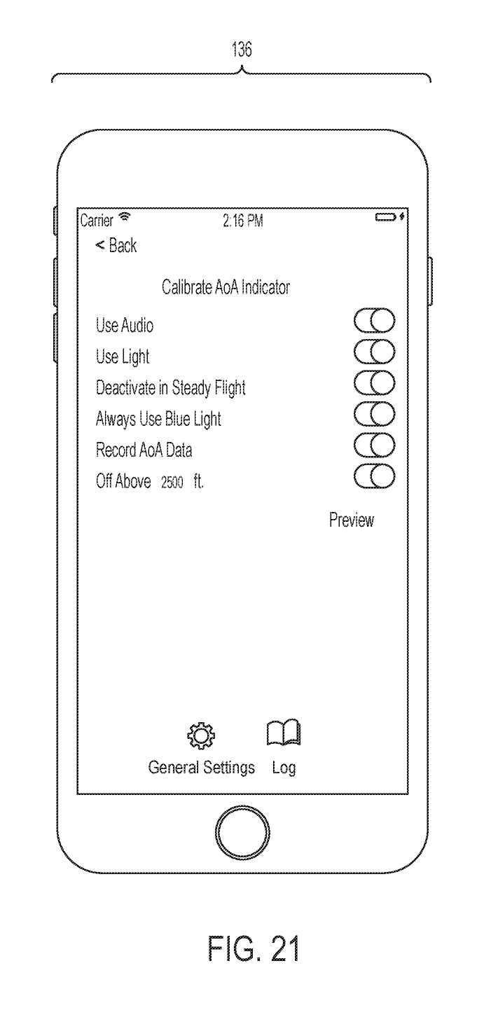

When used as an AoA indicator, the control unit 124 may act as a slave to an external master device 170 connected to an AoA sensor 172, such as a vane transmitter fitted to the airplane. The external master device 170 may send wireless signals (e.g., BLUETOOTH™ signals) to the control unit 124, and thus, the Airplane Pilot AoA Indicator mode may require that the control unit 124 is in a wireless communication mode. Once the wireless communication mode is activated, a user may connect the smartphone app to the external master device 170 to configure the settings, as shown in FIG. 21. Once the external master device 170 has been pre-calibrated, in which the pilot may be led through a series of steps by the smartphone app, and in which certain aeronautical maneuvers may be performed, the LEDs 108 on the eyewear device 100 may make use of the entire available spectrum between two known colors, such as green and red (hue values 120 degrees to 0 degrees), to indicate AoA. In the case of green and red, the color red (0 degrees) may indicate that one is approaching the stall point of the aircraft, while green may indicate the aircraft is away from the stall point of the aircraft.

When the device 170 senses that that aircraft is landing (e.g., when the airplane descends below 1000 ft.), the AoA indicator may work the same, but the LEDs 108 may turn blue to indicate the optimum AoA for a short-field landing approach. This can also be a default mode for those who may need to practice landing maneuvers at higher altitude, or for pilots flying skydivers who may need to fly an optimum AoA on a jump run.

The user may also configure the system to user Geiger-counter-like clicking sounds that speed up and increase in intensity to create an audible pitch at 20 Hz as the AoA nears the stall point. One may optionally record the AoA data in the external master device 170 and view it on the app. The LEDs 108 and speakers 144 may be made to deactivate when the external device 170 senses a steady state cruise for a predetermined period of time, or when the device is above a specified altitude.

This system may have several advantages, such as the integration of an AoA indicator into eyewear may act to reduce clutter on an instrument panel of an aircraft. Furthermore, the LEDs on the eyewear device 100 may allow for more gradations of color to be used, which may already be known to pilots familiar with AoA indicators. Additionally, the indications given by the device may be always visible or audible, regardless of what direction a pilot may be looking.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1-20. (canceled)

21. An eyewear device for use when skydiving, the eyewear device comprising:
a lens positionable over a user's eyes, the lens defining a viewing axis passing through the lens and dividing the lens into a pair of lateral regions;
a compass to detect a directional heading of the viewing axis of the lens and generate a first signal representative of the detected directional heading;
a controller in communication with the compass to receive the first signal from the compass, and generate a light command signal based on a comparison of the detected directional heading with a preset directional heading range; and
a pair of lights in operative communication with the controller and located in respective ones of the pair of lateral regions of the lens, the pair of lights capable of operating based on the light command signal to emit a visual alert to convey directional guidance to the user.

22. The eyewear device recited in claim 21, wherein the light command signal includes instructions for operating the pair of lights in a first mode when the detected directional heading falls within the preset directional heading range and in a second mode when detected directional heading falls outside of preset directional heading range.

23. The eyewear device recited in claim 22, wherein in the first mode, the pair of lights emit a common color of light, and in the second mode, the pair of lights emit different colors of light.

24. The eyewear device recited in claim 22, wherein in the first mode, the pair of lights emit light at a common refresh rate, and in the second mode, the pair of lights emit light at a different refresh rate.

25. The eyewear device recited in claim 21, wherein the pair of lights emit the visual alert at a refresh rate that is imperceptible to a human user.

26. The eyewear device recited in claim 25, wherein the pair of lights emit the visual alert at a refresh rate that is greater than 30 Hz.

27. The eyewear device recited in claim 21, further comprising:
an altimeter in communication with the controller and operative to determine an altitude of the altimeter;
the pair of lights being in operative communication with the altimeter to emit the visual alert having a color representative of the determined altitude.

28. The eyewear device recited in claim 21, further comprising a speaker coupled to the lens, the speaker being capable of emitting an audible signal to the user.

29. The eyewear device recited in claim 28, wherein the controller generates an audible command signal based on a comparison of the detected directional heading with a preset directional heading range, the speaker being in communication with the controller to receive the audible command signal therefrom and generate the audible signal based on the audible command signal.

30. The eyewear device recited in claim 29, further comprising:
a microphone to detect magnitude of ambient noise and generate an ambient noise signal;
the controller being in communication with the microphone and generates the audible command signal based on detected magnitude of ambient noise.

31. The eyewear device recited in claim 29, further comprising:
a light sensor to detect a level of ambient light and generate an ambient light signal;
the controller being in communication with the light sensor and generates the light command signal based on detected level of ambient light.

32. A wearable device for providing directional guidance to a skydiver, the device comprising:
a frame wearable by the skydiver and defining a frame axis, the frame having a pair of lateral regions;
a compass to detect a directional heading of the frame axis and generate a first signal representative of the detected directional heading;
a controller in communication with the compass to receive the first signal from the compass, and generate a light command signal based on a comparison of the detected directional heading with a preset directional heading range; and
a pair of lights in operative communication with the controller and located in respective ones of the pair of lateral regions of the frame, the pair of lights capable of operating based on the light command signal to emit a visual alert to convey directional guidance to the user.

33. The eyewear device recited in claim 32 wherein the light command signal includes instructions for operating the pair of lights in a first mode when the detected directional heading falls within the preset directional heading range and in a second mode when detected directional heading falls outside of preset directional heading range.

34. The eyewear device recited in claim 33, wherein in the first mode, the pair of lights emit a common color of light, and in the second mode, the pair of lights emit different colors of light.

35. The eyewear device recited in claim 33, wherein in the first mode, the pair of lights emit light at a common refresh rate, and in the second mode, the pair of lights emit light at a different refresh rate.

36. The eyewear device recited in claim 32, wherein the pair of lights emit the visual alert at a refresh rate that is imperceptible to a human user.

37. The eyewear device recited in claim 36, wherein the pair of lights emit the visual alert at a refresh rate that is greater than 30 Hz.

38. The eyewear device recited in claim 32, further comprising:
an altimeter in communication with the controller and operative to determine an altitude of the altimeter;
the pair of lights being in operative communication with the altimeter to emit the visual alert having a color representative of the determined altitude.

39. The eyewear device recited in claim 32, further comprising a speaker coupled to the lens, the speaker being capable of emitting an audible signal to the user.

40. The eyewear device recited in claim 38, wherein the controller generates an audible command signal based on a comparison of the detected directional heading with a preset directional heading range, the speaker being in communication with the controller to receive the audible command signal therefrom and generate the audible signal based on the audible command signal.
